(19) United States
(12) Patent Application Publication
(10) Pub. No.: US 2020/0137841 A1
(43) Pub. Date: Apr. 30, 2020

(54) PULL-OUT GUIDE AND MICROWAVE COOKING APPLIANCE OR INDUSTRIAL OVEN WITH A PULL-OUT GUIDE

(71) Applicant: PAUL HETTICH GMBH & CO. KG, Kirchlengern (DE)

(72) Inventors: Johann-Sebastian LESSMANN, Kirchlengern (DE); Johannes TIWISINA, Borgholzhausen (DE); Willi GRIGAT, Bielefeld (DE)

(21) Appl. No.: 16/495,919

(22) PCT Filed: Mar. 22, 2018
(86) PCT No.: PCT/EP2018/057259

§ 371 Date: Sep. 20, 2019

(30) Foreign Application Priority Data
Mar. 22, 2017 (DE) 10 2017 106 104.5

(51) Int. Cl. H05B 6/64; F27D 3/12; F24C 15/16

(52) U.S. Cl. CPC H05B 6/6408; F24C 15/168; H05B 6/642; F27D 3/12

(57) ABSTRACT

A pull-out guide for a microwave cooking appliance or an industrial oven includes a body rail and a running rail, that is able to move relative thereto, for depositing a carrier, and a microwave shield for shielding the pull-out guide from microwaves. The running rail is only partially shielded.

### BACKGROUND AND SUMMARY OF THE INVENTION

Exemplary embodiments of the invention relate to a pull-out guide for a microwave cooking appliance or an industrial furnace, comprising a body rail and a running rail, movable relative thereto, for depositing a support, in particular a food support, and a microwave shield for shielding the pull-out guide against microwaves. The invention also relates to a microwave cooking appliance or an industrial furnace having such a pull-out guide.

In cooking appliances such as ovens, pull-out guides have become mainstream, by means of which a food support, such as a baking tray, can easily be pulled out from a cooking chamber of the appliance in order then to be able to be removed more easily or to test whether the food is cooked, without there being any risk of tilting of the food support.

In cooking appliances that heat or cook food by microwave radiation exclusively or as an alternative to or in combination with other cooking methods, all the components arranged in the cooking chamber are subject to specific restrictions due to the microwave radiation. Components built into the cooking chamber, including pull-out guides, must be prevented from absorbing energy from the microwave radiation and as a result becoming hot or dissipating the absorbed energy in an undesired manner. Heating is undesirable from an energy point of view, and can lead to damage to the pull-out guide or other components in the cooking chamber or even to a risk of fire. In addition, there is a risk of formation of plasma discharges, which are likewise undesirable from an energy point of view and also with regard to a destructive effect. A similar problem exists in the case of industrial furnaces which use microwave radiation for heating purposes.

Document DE 4142346 A1 discloses a pull-out guide for a microwave cooking appliance, in which the running rail of the pull-out guide is surrounded by a shielding rail having a closed hollow cross-sectional profile, or in which the running rail itself is configured as a shielding rail. The actual pull-out guide is shielded by the shielding rail in such a way that the internal components of the pull-out guide are inaccessible to microwave radiation.

One disadvantage of this design is that, due to the configuration with a closed hollow cross-sectional profile, direct support of the pull-out guide in the area in which the running rail moves is not possible. The pull-out rail can therefore be fixedly mounted only in a rear end region and must be guided in a front region, for example by a guide roller that is rotatably attached to a side wall of the cooking chamber. Such a guide roller leads to additional space being required for the pull-out guide and does not enable a full extension/over-extension design. In addition, such an exposed guide roller is difficult to clean.

Exemplary embodiments of the present invention are directed to a pull-out guide which, without additional external guide elements, that can be used in a cooking chamber or heating chamber that uses microwave radiation. Additionally, exemplary embodiments are directed to a microwave cooking appliance or an industrial furnace having such a pull-out guide.

A pull-out guide according to the invention, of the type mentioned in the introduction, is characterized in that the microwave shield is configured in such a way that the running rail is only partially shielded.

The partial shielding may be achieved in that the running rail is fully shielded only in the retracted state of the running rail, whereas the running rail is not fully shielded in the extended or partially extended state.

The partial shielding may alternatively or additionally also be achieved in that, in the retracted state and also in the partially or fully extended state, the running rail is geometrically not fully covered along its sides, but rather only partially. This is based on the knowledge that incomplete shielding is permissible under certain circumstances.

In one advantageous embodiment of the pull-out guide, the microwave shield is formed in at least two parts, wherein a first part is attached to the body rail and a second part is attached to the running rail. In this way, a microwave shield can be formed which, in the retracted state of the pull-out guide, fully or partially surrounds the pull-out guide and thus shields critical regions of the pull-out guide against the microwave radiation. The fact that, due to the two-part design, this shielding does not occur when the running rail is extended is not important since, when the running rail is extended, a door bounding the interior space is opened and the microwave emitter is switched off. Attaching the first part of the microwave shield to the body rail enables this part to be stationary, as a result of which it does not collide with a (likewise stationary) mounting element for the body rail.

In one embodiment, the first part may be a first U-shaped profile rail with lateral legs and the second part may be a second U-shaped profile rail with lateral legs. The two U-shaped profile rails engage in one another and at least in some sections overlap laterally with their legs. Thus, a shield in the retracted state is sealed against microwaves is formed.

Preferably, the first and the second U-shaped profile rail may be tapered in their longitudinal direction. As a result, the profile rails in the retracted state can bear against one another in the overlapping region without any gaps, the legs of the profile rails moving away from one another as the running rail is extended. Extension of the running rail is thus not hindered by sections of the profile rails rubbing against one another.

In a further embodiment, the first part may be at least a first strip-shaped shielding plate and the second part may be at least a second strip-shaped shielding plate. The two shielding plates are arranged laterally on the pull-out guide and, at least in the retracted state of the pull-out guide, overlap one another along a respective longitudinal edge or bear against one another with the respective longitudinal edges.

Preferably, the longitudinal edges run in a sloping manner with respect to a pull-out direction, as a result of which once again a closed shield can be achieved in the retracted state of the pull-out guide, without the shielding plates rubbing against one another as the running rail is extended.

In one advantageous embodiment of the pull-out guide, the first part is a U-shaped profile rail with lateral legs, whereas the second part comprises a plurality of contact elements that make contact with the U-shaped profile rail in a contact area. The body rail thus acts together with the U-shaped profile rail and the contact elements as a microwave shield, wherein any gap that remains between the body rail and the U-shaped profile rail is preferably divided by the contact elements into sections that are so short as to prevent any penetration of microwave radiation. The contact elements additionally ensure that the U-shaped profile rail and thus the running rail is at the same electric potential as the body rail at all times.

In a two-part configuration of the microwave shield, the contact elements may be attached to the body rail. However, it is also conceivable to form the microwave shield in one piece, wherein the U-shaped profile rail is mounted on the running rail and carries the contact elements, which then make contact with the body rail.

In both cases, the contact area of the U-shaped profile rail may comprise a channel, into which the contact elements protrude.

In another embodiment, in which the microwave shield is formed in one piece and is attached to the running rail, the microwave shield may once again be configured as a U-shaped profile rail with lateral legs that has a plurality of contact elements contacting the body rail. In this case, the contact elements may each have a latching head, which is inserted in latching openings of the U-shaped profile rail, and contact springs connected thereto. In order to provide space for the contact elements, in this case the lateral legs of the U-shaped profile rail may be inclined relative to one another, so that the U-shaped profile rail widens in the downward direction.

In one advantageous embodiment of the pull-out guide, the microwave shield comprises a rectangular profile rail surrounding the body rail and the running rail and which has a slot along one longitudinal side. Any penetration of microwave radiation into a slot positioned preferably adjacent to a side wall of the cooking chamber is either prevented or reduced to a very low intensity of any penetrating portion of the radiation. The slot advantageously makes it possible to use mounting elements, for example mounting brackets, for the body rail, since the body rail is accessible from outside through the slot.

A microwave cooking appliance according to the invention or an industrial furnace according to the invention has at least one such pull-out guide. The advantages mentioned in connection with the pull-out guide are achieved.

### BRIEF DESCRIPTION OF THE DRAWING FIGURES

The invention will be explained in greater detail below on the basis of exemplary embodiments and with reference to figures. In the figures:

FIGS. 1a-c show a first exemplary embodiment of a pull-out guide according to the invention in different views;

FIGS. 2a-c show a second exemplary embodiment of a pull-out guide according to the invention in different views;

FIGS. 3a-c show a third exemplary embodiment of a pull-out guide according to the invention in different views;

FIGS. 4a-c show a fourth exemplary embodiment of a pull-out guide according to the invention in different views; and

FIGS. 5a-c show a fifth exemplary embodiment of a pull-out guide according to the invention in different views.

### DETAILED DESCRIPTION

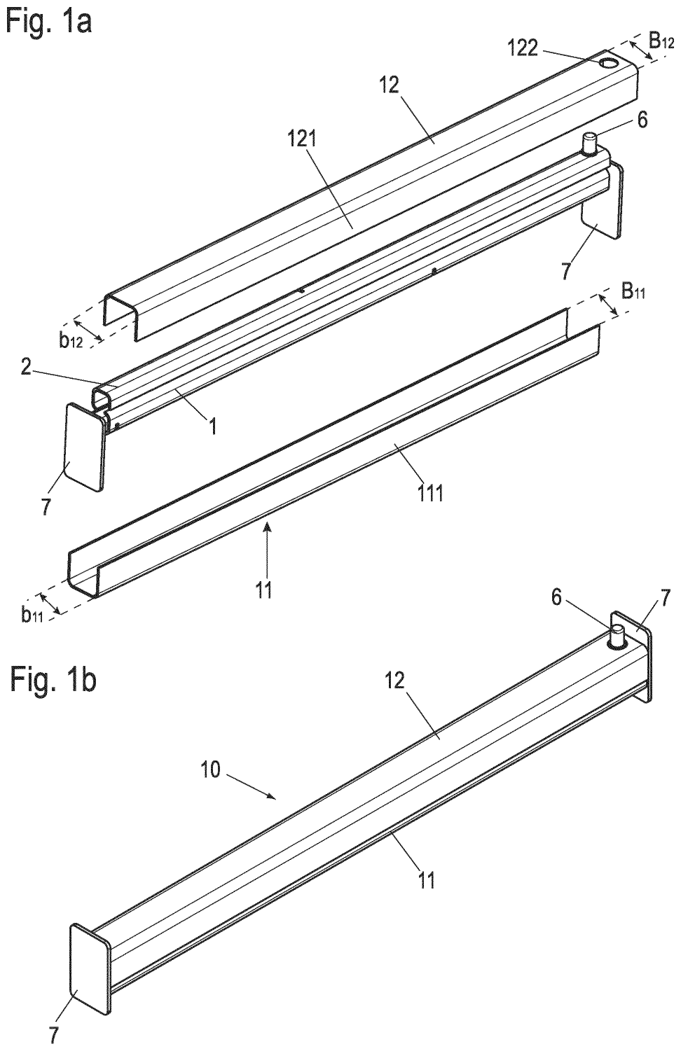

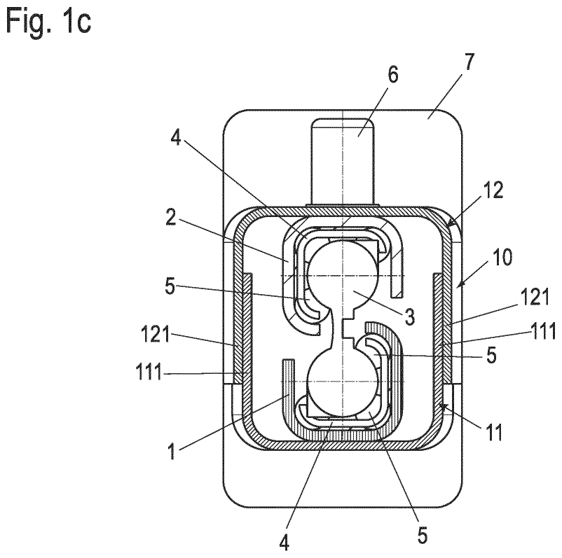

FIGS. 1a to 1c show a first exemplary embodiment of a pull-out guide for a microwave cooking appliance.

Here, a microwave cooking appliance is to be understood to mean a microwave oven or a so-called combination cooking appliance providing a thermal cooking function as an alternative to or in addition to a microwave cooking function. Usually at least two such pull-out guides are placed at the same height on the left-hand side and on the right-hand side in a cooking chamber, in order to be able to place a food support thereon, for example a baking tray or a rack, and to be able to guide the latter horizontally out of the cooking chamber. Such pull-out guides may optionally be arranged at multiple levels one above the other. However, it is also conceivable to use a pull-out guide according to the invention in an industrial furnace, for example in the field of heating or crosslinking plastics.

The pull-out guide is shown in an isometric exploded view in FIG. 1a and in an isometric view in the assembled state in FIG. 1b. FIG. 1c shows a section perpendicular to the longitudinal extension of the pull-out rails, that is to say in a plane perpendicular to the pull-out direction.

The pull-out guide comprises a body rail 1 and a running rail 2, which is arranged above the body rail 1 and is guided displaceably relative thereto. As shown in FIG. 1c shows, the pull-out guide is configured as a full extension and has a middle rail 3 that is displaceable both relative to the body rail 1 and relative to the running rail 2. The body rail 1 and the running rail 2 are each configured as a non-closed square profile having a partially open side. These partially open sides of the profiles of the body rail 1 and of the running rail 2 face towards one another, so that the middle rail 3 can extend in each case into the interior of the body rail 1 and of the running rail 2. The middle rail 3 is displaceably guided in the body rail 1 and in the running rail 2 via, in each case, at least one rolling element cage 4, in which a plurality of rolling elements 5 are held.

The food support is placed onto the upper of the rails, the running rail 2. To secure the food support against displacement, a pin 6, which protrudes vertically upwards, is connected to the running rail 2 and bounds the running rail 2 towards the rear (as seen in the pull-out direction). The food support may bear against this pin 6, or the pin 6 may be passed through a corresponding hole or aperture in the food support. On the end sides, the pull-out guide is covered by end covers 7, each of the end covers 7 being connected to one of the rails 1, 2. The rear end cover 7, which is adjacent to the pin 6 in FIGS. 1a and 1b, is connected to the body rail 1, and the front end cover 7 is connected to the running rail 2.

According to the invention, a microwave shield 10 is provided which, in the first exemplary embodiment shown, comprises two U-shaped profile rails engaging in one another. A first (lower) U-shaped profile rail 11 is connected to the body rail 1 and is thus arranged in a stationary manner in the cooking chamber. A second (upper) U-shaped profile rail 12 is placed over the running rail 2 and is connected to the latter, for example by means of a spot weld. To this end, the upper profile rail 12 has an aperture 122, through which the pin 6 protrudes upwards.

Lateral legs 121 of the upper U-shaped profile rail 12 are spaced apart from one another by a greater distance than corresponding legs 111 of the lower profile rail 11, so that the upper profile rail 12 engages laterally over the lower profile rail 11. The legs 111, 121 of the lower and upper profile rail 11, 12 may be spaced at a small distance from one another or may bear against one another without any gap or with barely any gap, as shown symbolically in FIG. 1c.

Due to the two U-shaped profile rails 11, 12 engaging in one another, the body rail 1 and the running rail 2 of the pull-out guide are enclosed in a manner sealed against microwaves when the pull-out guide is fully retracted. Microwaves are thus unable to reach the smaller components of the pull-out guide, for example the rolling elements 5, which optionally act as antennas, and therefore, in the retracted state of the running rail 2, the pull-out guide shown is suitable for use with microwaves.

Despite the fact that the pull-out guide is fully covered in the retracted state, the body rail 1 is indirectly or directly accessible on its lower side for mounting elements, for example mounting brackets, in order to be able to be mounted in the cooking chamber.

Advantageously, as in the case shown, the U-shaped profile rails 11, 12 are tapered in the longitudinal direction, that is to say that the width (the distance between the two lateral legs) becomes narrower in the pull-out direction from the rear towards the front. As shown in FIG. 1a, a width of the lower profile 11 tapers from a value B₁₁ to a value b₁₁, where B₁₁>b₁₁ holds for the widths. In the same way, the upper U-shaped profile rail 12 tapers in its width in the pull-out direction from a value B₁₂ to a value b₁₂, where once again B₁₂>b₁₂. As mentioned above, the upper U-shaped profile rail engages over the lower U-shaped profile rail at every point, so that it is also true that B₁₂>B₁₁ and b₁₂>b₁₁.

The tapered design of the two U-shaped profile rails 11, 12 has the result that the legs 111, 121 touch one another in the fully retracted state of the pull-out guide, whereas they are increasingly spaced apart from one another as the pull-out guide is extended. In this way, a microwave shield 10 that is sealed and has no gaps is formed in the retracted state of the pull-out guide, yet this does not prevent the pull-out guide from being opened easily and with as little friction as possible.

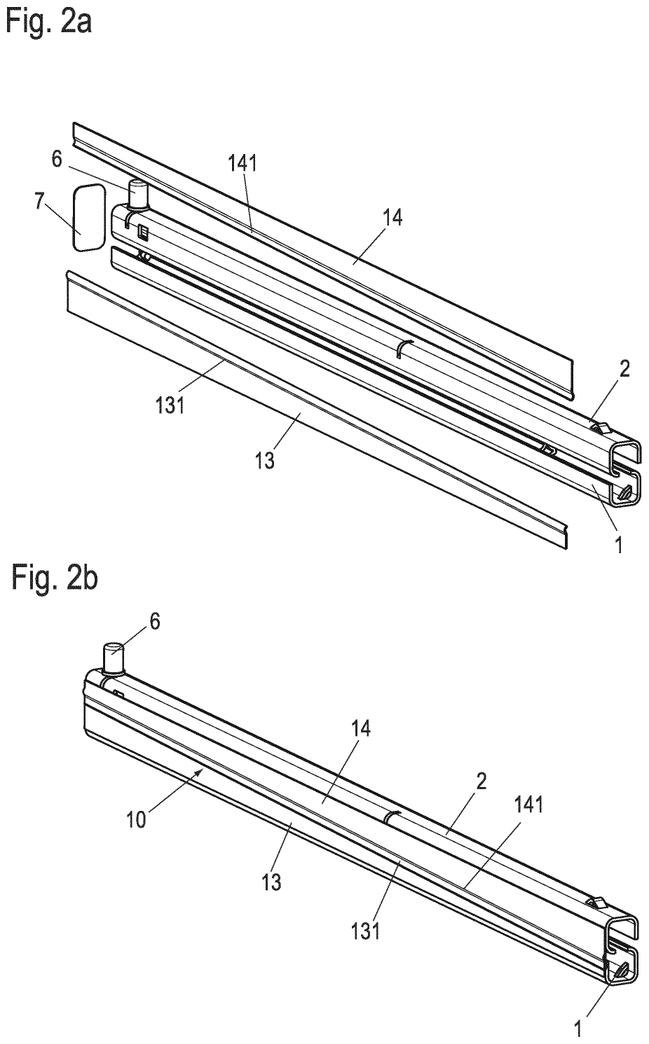

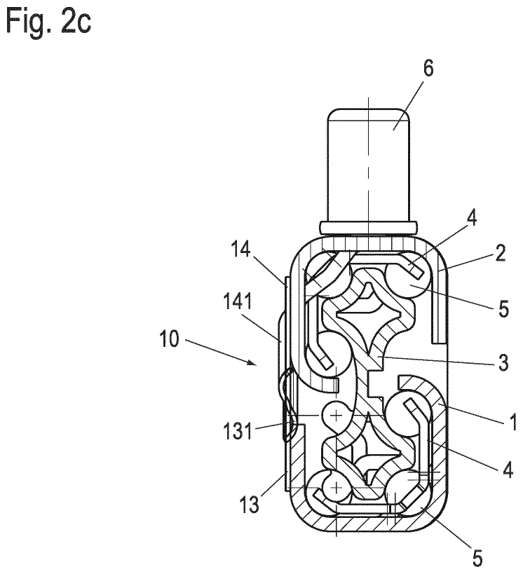

FIGS. 2a to 2c, 3a to 3c, 4a to 4c and 5a to 5c each show a further exemplary embodiment of a pull-out guide according to the application. In all the exemplary embodiments, the same reference signs denote elements which are identical or equivalent to those in the examples of FIGS. 1a to 1c.

Furthermore, in all the exemplary embodiments, the pull-out guide is shown in an isometric exploded view in the figure bearing the suffix “a”, in an isometric view in an assembled state in the figure bearing the suffix “b”, and in a sectional view in the figure bearing the suffix “c”.

With regard to the basic structure, the pull-out guide is in all cases formed in the same way as in the exemplary embodiment of FIGS. 1a to 1c, to the description of which reference is hereby explicitly made.

In particular, the pull-out guide in each case has a stationary body rail 1 and a running rail 2 which is mounted such as to be displaceable relative thereto. At least one middle rail 3 may be arranged between the body rail 1 and the running rail 2, which middle rail is mounted displaceably in the body rail 1 and/or the running rail 2 in each case via rolling elements 5 which are positioned in a rolling element cage 4. However, an arrangement without a middle rail (partial pull-out) is also conceivable. In each case, an optional pin 6 is arranged on the running rail 2, which pin serves to fix a food support placed thereon. Optional end covers 7 are provided on the end sides, but these are not shown in all drawings.

In each exemplary embodiment shown, a microwave shield 10 is provided, but these differ from one other in the individual exemplary embodiments. The configuration of the microwave shield 10 will be described in greater detail below for each exemplary embodiment.

In the exemplary embodiment of FIGS. 2a to 2c, the microwave shield 10 comprises two shielding plates 13, 14, of which a first (lower) shielding plate 13 is connected to the body rail 1 and a second (upper) shielding plate 14 is connected to the running rail 2. The two shielding plates 13, 14 extend over the entire length of the pull-out guide. The two shielding plates 13, 14 bear against one another with their mutually facing side edges 131 and 141 when the pull-out guide is fully retracted. A gap between the two rails of the pull-out guide, that is to say the body rail 1 and the running rail 2, is thus completely or at least partially closed by a relatively planar arrangement of the two shielding plates 13, 14, so that no microwaves can penetrate.

The two mutually facing edges 131, 141 of the shielding plates 13, 14 are sloping so that, as the running rail 2 is being extended, these edges 131, 141 do not rub against one another but rather are at a distance from one another. The longitudinal edges 131, 141 may also be configured as a profiled edge or semi-circular edge for the sake of better contacting. Once again, in a manner similar to the exemplary embodiment of FIGS. 1a to 1c, a shield is thus formed which on the one hand is closed and on the other hand does not hinder extension of the pull-out guide.

A comparable arrangement of shielding plates 13, 14 could in principle also be arranged on the opposite side of the pull-out guide, in order likewise to close the gap formed there between the body rail 1 and the running rail 2 in the retracted state of the pull-out guide. However, since this side of the pull-out guide is often positioned relatively close to the metal side wall of the cooking chamber, microwaves are already prevented from penetrating into this gap by the shielding effect of the side wall. Therefore, assuming that the pull-out rail is appropriately installed in the cooking chamber of the cooking appliance, there is no need to provide a shield on this side.

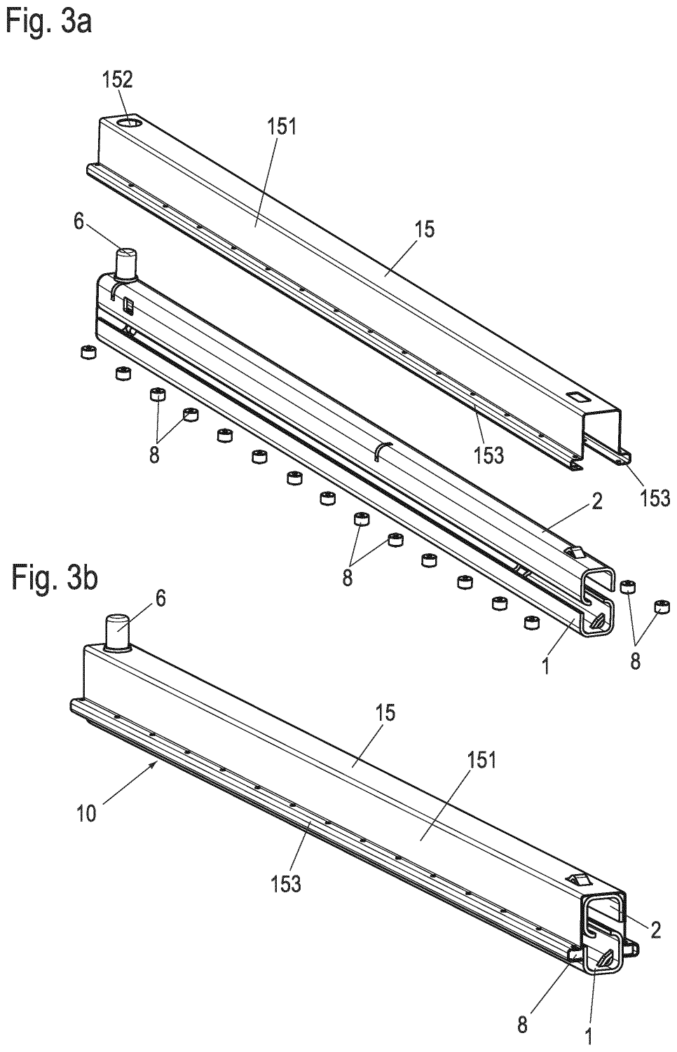

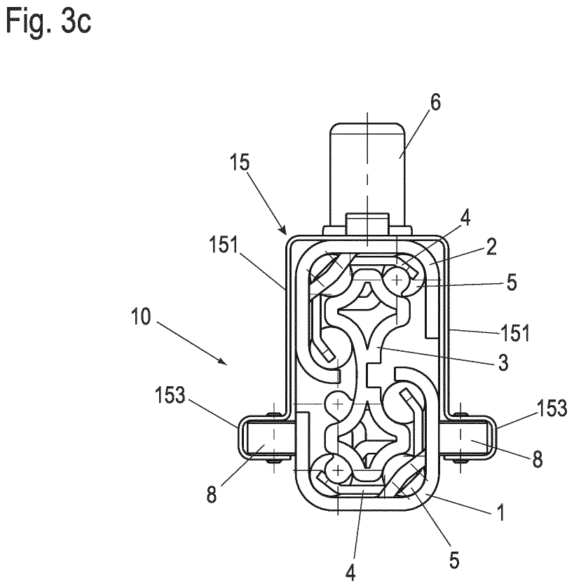

In the exemplary embodiment of FIGS. 3a to 3c, the microwave shield 10 comprises just one U-shaped profile rail 15, which extends over the entire length in the retracted state of the pull-out guide and which is placed onto the running rail 2 from above and is attached to the latter. Inwardly open channels 153 are formed at both free ends of legs 151 of the U-shaped profile rail 15, the channels in turn having a U-shaped cross-section.

A plurality of contact elements 8 are mounted laterally in these open channels 153 or on the body rail 1, preferably at regular intervals, the contact elements being positioned in the lateral channels 153 in the assembled state of the pull-out guide, which is shown in FIGS. 3b and 3c. The contact elements 8 serve as guide elements and bring the U-shaped profile rail 15 into contact with the body rail 1 in the retracted state of the pull-out guide, at intervals of one to a few centimetres.

In the embodiment shown, the contact elements 8 are rolling elements which are held in the open channels 153 in a rotatably mounted manner and roll on the body rail. In an alternative embodiment, the contact elements 8 may also be contact springs, which are arranged either in the channels 153 or on the body rail 1 and make frictional contact with the respective other of these elements as the running rail 2 moves. A combination of spring-effect, frictional and/or rolling contact elements can also be used.

The contact elements may comprise an electrically conductive material, in particular a metal and/or graphite and/or an electrically conductive plastic. Preferred metals are copper, brass or bronze, due to the good conductivity thereof. As electrically conductive materials, use may be made for example of polyketone (POK), polypropylene (PP), thermoplastic polyurethane (TPU) and/or polyetheretherketone (PEEK), which is made electrically conductive by way of suitable additives, usually carbon particles such as carbon black.

The contact elements may be made entirely or partially of the aforementioned materials. It is also possible that a core, which may be made of an electrically conductive material or also a non-conductive material, is surrounded by an electrically conductive and flexible material. The electrically conductive and flexible material is for example a knitted or woven fabric formed of conductive threads or comprises conductive brushes or bristles.

The contact elements may be configured in such a way that they keep the pull-out guide in a retracted position by way of a friction fit and/or form fit. The contact elements thus advantageously also implement a keep-closed function, which is often desired in microwave cooking appliances. This serves for example to maintain a distance between for example the door of the microwave cooking appliance and the front-end cover, thereby additionally preventing (spark) discharges between these elements. In alternative embodiments, however, it is also possible to implement the keep-closed function via separate components.

The body rail 1 acts together with the U-shaped profile rail 15 and the contact elements 8 as a microwave shield 10, wherein any gap that still remains between the body rail 1 and the U-shaped profile rail 15 is divided by the contact elements 8 into sections that are so short as to prevent penetration of microwave radiation. The contact elements 8 additionally ensure that the U-shaped profile rail 15 and thus the running rail 2 is at the same electric potential as the body rail 1 at all times. Discharges between the body rail 1 and the running rail 2 are thus prevented. With regard to DC voltage, assuming ideal contact, there is already a local equalization of potential between the body rail 1 and the running rail 2 due to the rolling elements 5, which are usually made of metal, and the middle rail 3, which is likewise made of metal. However, since the rolling element cages 4 do not extend over the entire length of the pull-out guide, an equalization of potential via the rolling elements 5 alone is not guaranteed with regard to high-frequency excitation.

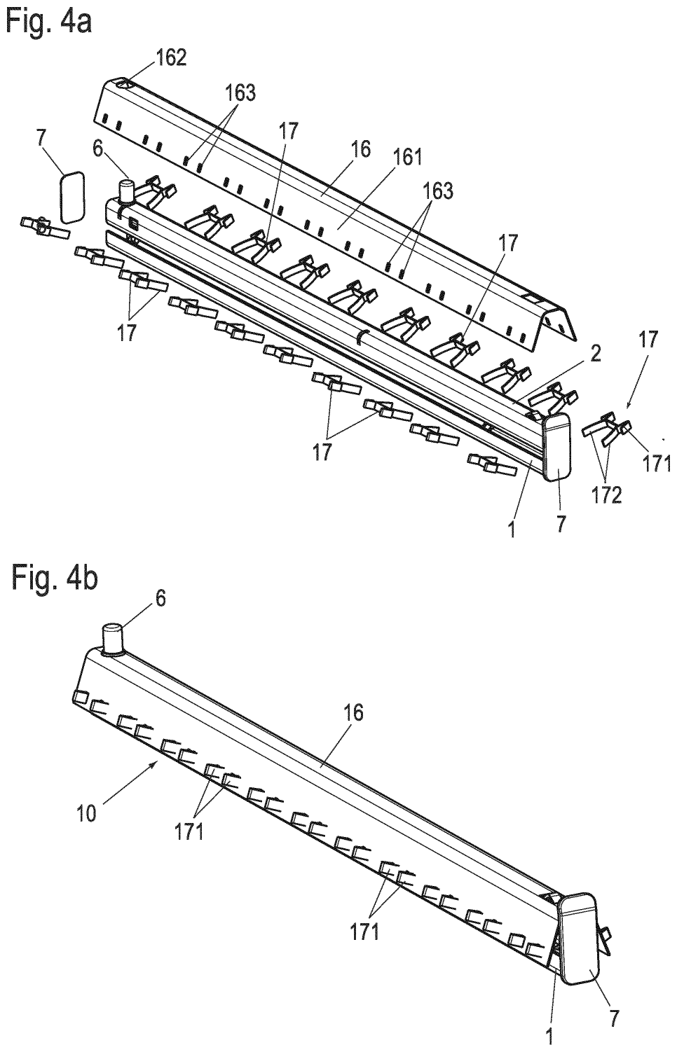

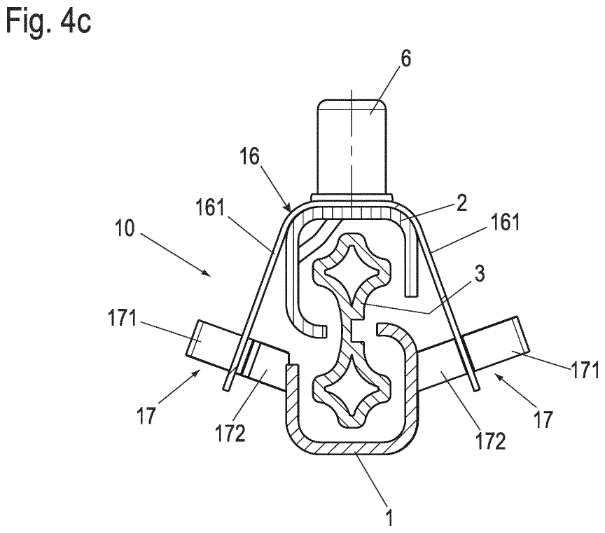

FIGS. 4a-4c show another exemplary embodiment of a pull-out guide, in which a basic principle similar to that in the exemplary embodiment of FIGS. 3a-3c is implemented. Once again, a U-shaped profile rail 16 is placed onto the running rail 2 and, via contact elements, makes contact with the body rail 1 at a plurality of contact points which are distributed preferably at regular intervals over the length of the pull-out guide.

In this exemplary embodiment, the U-shaped profile rail 16 is widened, that is to say has legs 161 flaring outwards in the downward direction. Arranged along a lower edge of the legs 161 is a plurality of latching openings 163, into which contact elements 17 are inserted. The contact elements 17 have a latching head 171 that latches into, in each case, two adjacent latching openings 163 of the U-shaped profile rail 16. Projecting from the latching head 171 are inwardly protruding contact springs 172, which make contact with the body rail 1.

In contrast to an embodiment in which the contact elements 8 are mounted on the body rail 1, in the present example a commercially available pull-out guide can serve as the basis for the pull-out guide shown, onto which the U-shaped profile rail 16 is placed and is connected to the running rail 2. No modification to the body rail 1 is required.

In the two exemplary embodiments shown in FIGS. 3a-3c and 4a-4c implementing this basic principle, the lower side of the body rail 1 is freely accessible and thus can be used for mounting the pull-out guide, for example directly by means of mounting brackets.

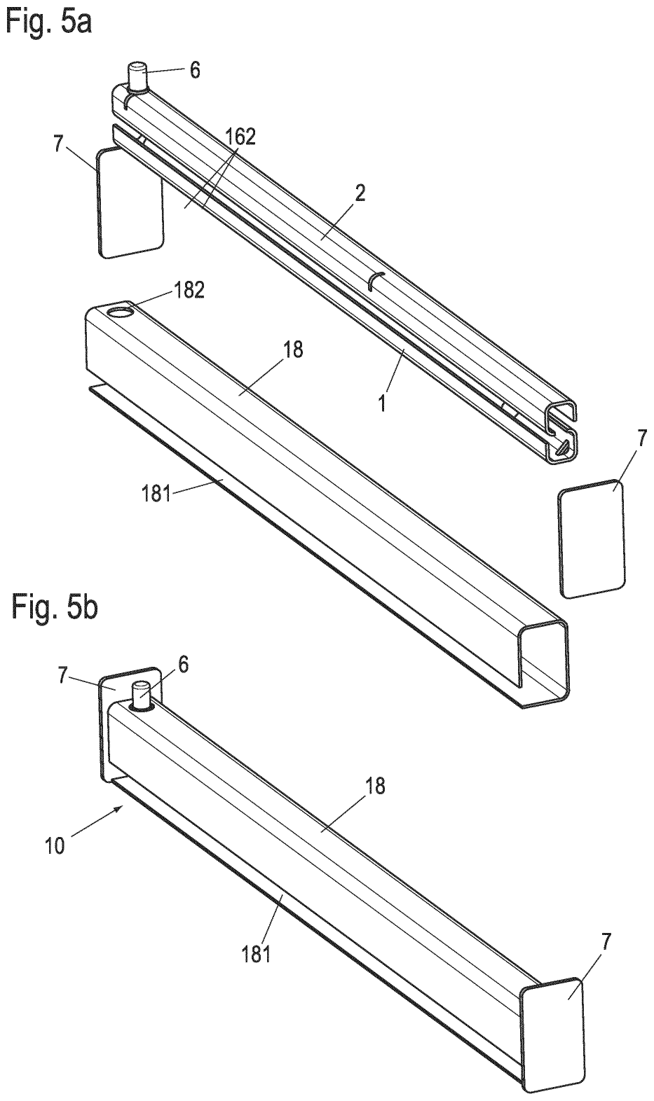

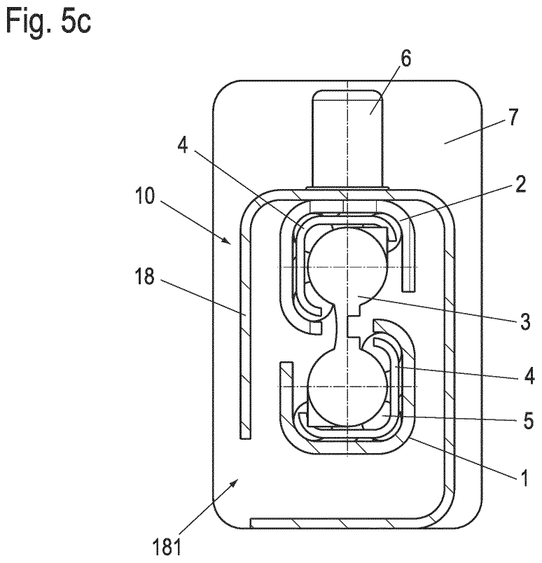

The exemplary embodiment of FIGS. 5a-5c also shows a microwave shield 10 having just one profile rail, which in this case bears reference sign 18. The profile rail 18 has a substantially rectangular profile surrounding the body rail 1 and the running rail 2.

A slot 181 is cut out on one of the sides, the slot extending here over the entire length of the profile rail 18 and having a height of a few millimetres.

When the pull-out guide is arranged in the cooking chamber of a microwave appliance, the slotted side of the profile rail 18 preferably faces towards the side wall of the cooking chamber. The profile rail 18 is preferably arranged as close to the side wall as possible, for example at a distance of a few millimeters therefrom. As already explained in connection with the exemplary embodiment of FIGS. 2a-2c, microwave radiation is unable to penetrate into a slot 181 positioned in this way, or any portion of the radiation that does penetrate has a lower intensity. The slot 181 advantageously enables once again the use of mounting elements, for example mounting brackets, for the body rail, since the body rail 1 is accessible from outside through the slot.

In the exemplary embodiments shown, in one further development the end cover 7 may be coated or covered with an electrically non-conductive material, for example with a ceramic material. This electrically non-conductive material serves as a spacer between the running rail 2 and a rear wall of the cooking chamber and/or a door of the microwave cooking appliance. Even if high electric potentials build up on the pull-out guide and/or on the door, spark discharges are thus avoided. In addition, the aforementioned keep-closed mechanism may serve to maintain a distance between, for example, the door of the microwave cooking appliance and the front-end cover 7, thereby preventing (spark) discharges. Non-conductive spacers on one of the end covers 7 may additionally be applied to the rear side of the end covers 7. They then serve as spacers between the end cover 7 in question and the respective other rail of the pull-out guide, in order to prevent a (spark) discharge at this location when the pull-out guide is retracted.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 body rail
2 running rail
3 middle rail
4 rolling element cage
5 rolling element
6 pin
7 end cover
8 contact element
10 shield
11 first U-shaped profile rail
111 leg
12 second U-shaped profile rail
121 leg
122 aperture
13 first shielding plate
131 sloping edge
14 second shielding plate
141 sloping edge
15 U-shaped profile rail
161 leg
152 aperture
153 channel
16 U-shaped profile rail
151 leg
162 aperture
163 latching opening
17 contact element
171 latching head
172 contact spring
18 U-shaped profile rail
181 slot
182 aperture

1-15. (canceled)

16. A pull-out guide for a microwave cooking appliance or an industrial furnace, the pull-out guide comprising:
a body rail;
a running rail configured to be movable relative to the body rail, wherein the running rail is further configured for depositing a support; and
a microwave shield configured to shield the pull-out guide against microwaves, wherein the running rail is only partially shielded.

17. The pull-out guide of claim 16, wherein the microwave shield is formed in at least two parts, wherein a first part is attached to the body rail and a second part is attached to the running rail.

18. The pull-out guide of claim 17, wherein the first part of the microwave shield is a first U-shaped profile rail with lateral legs and the second part of the microwave shield is a second U-shaped profile rail with lateral legs, wherein the first and second U-shaped profile rails engage in one another and, at least in some sections, overlap one another laterally with their lateral legs.

19. The pull-out guide of claim 18, wherein the first U-shaped profile rail and the second U-shaped profile rail are tapered in a longitudinal direction of the pull-out guide.

20. The pull-out guide of claim 17, wherein the first part of the microwave shield is at least a first strip-shaped shielding plate and the second part of the microwave shield is at least a second strip-shaped shielding plate, wherein the first and second strip-shaped shielding plates are arranged laterally on the pull-out guide and, at least in a retracted state of the pull-out guide, overlap one another or bear against one another along a respective longitudinal edge.

21. The pull-out guide of claim 20, wherein the longitudinal edges of the first and second strip-shaped shielding plates run in a sloping manner with respect to a pull-out direction.

22. The pull-out guide of claim 17, wherein the first part of the microwave shield is a U-shaped profile rail with lateral legs and the second part of the microwave shield comprises a plurality of contact elements contacting the U-shaped profile rail in a contact area.

23. The pull-out guide of claim 22, wherein the plurality of contact elements are attached to the body rail and/or to the U-shaped profile rail.

24. The pull-out guide of claim 22, wherein the contact area comprises a channel, into which the plurality of contact elements protrude.

25. The pull-out guide of claim 16, wherein the microwave shield is formed in one piece and is attached to the running rail.

26. The pull-out guide of claim 25, wherein the microwave shield is a U-shaped profile rail with lateral legs having a plurality of contact elements contacting the body rail.

27. The pull-out guide of claim 26, wherein the plurality of contact elements each have a latching head, which is inserted in latching openings of the U-shaped profile rail, and contact springs connected thereto.

28. The pull-out guide of claim 26, wherein the lateral legs of the U-shaped profile rail are inclined relative to one another.

29. The pull-out guide of claim 25, wherein the microwave shield is a rectangular profile rail surrounding the body rail and the running rail and the rectangular profile rail has a slot along one longitudinal side.

30. A microwave cooking appliance or industrial furnace, comprising:
at least one pull-out guide, comprising
a body rail;
a running rail configured to be movable relative to the body rail, wherein the running rail is further configured for depositing a support; and
a microwave shield configured to shield the pull-out guide against microwaves, wherein the running rail is only partially shielded.
